(19) United States
(12) Patent Application Publication
(10) Pub. No.: US 2017/0108896 A1
(43) Pub. Date: Apr. 20, 2017

(54) SCREEN COVER AND ELECTRONIC DEVICE USING SAME

(71) Applicant: HON HAI PRECISION INDUSTRY CO., LTD., New Taipei (TW)

(72) Inventors: FENG-YUEN DAI, Tu-Cheng (TW); CHAU-JIN HU, Tu-Cheng (TW); KUN-CHAN WU, Tu-Cheng (TW); YING-JHIH HONG, Tu-Cheng (TW)

(21) Appl. No.: 14/967,668

(22) Filed: Dec. 14, 2015

(30) Foreign Application Priority Data
Oct. 19, 2015 (TW) 104134267

(51) Int. Cl. G06F 1/16; G06F 3/045; G06F 3/044

(52) U.S. Cl. CPC G06F 1/1637; G06F 3/044; G06F 3/045; G06F 2200/1634

(57) ABSTRACT

A screen cover is configured to protect a display screen of an electronic device. The screen cover includes an elongated member having a first side and a second side opposite the first side; a first surface on the first side; and a second surface on the second side and defining at least one optical microstructure. Each of the at least one optical microstructure is adjacent to an edge of the elongated member, and each optical microstructure includes at least one groove.

### FIELD

The subject matter herein generally relates to a screen cover and an electronic device using the screen cover.

### BACKGROUND

Electronic devices (such as mobile phones, tablet computers, and electronic books) have screens. The screen usually includes a display region and a frame around the display region.

### BRIEF DESCRIPTION OF THE DRAWINGS

Implementations of the present technology will now be described, by way of example only, with reference to the attached figures.

FIG. 1 is an isometric view of an exemplary embodiment of a screen cover.

FIG. 2 is a cross-sectional view of FIG. 1 along line II-II.

FIG. 3 is an enlarged view of III portion in FIG. 2.

FIG. 4 is an isometric view of an electronic device.

FIG. 5 is a cross-sectional view of FIG. 4 along line IV-IV.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

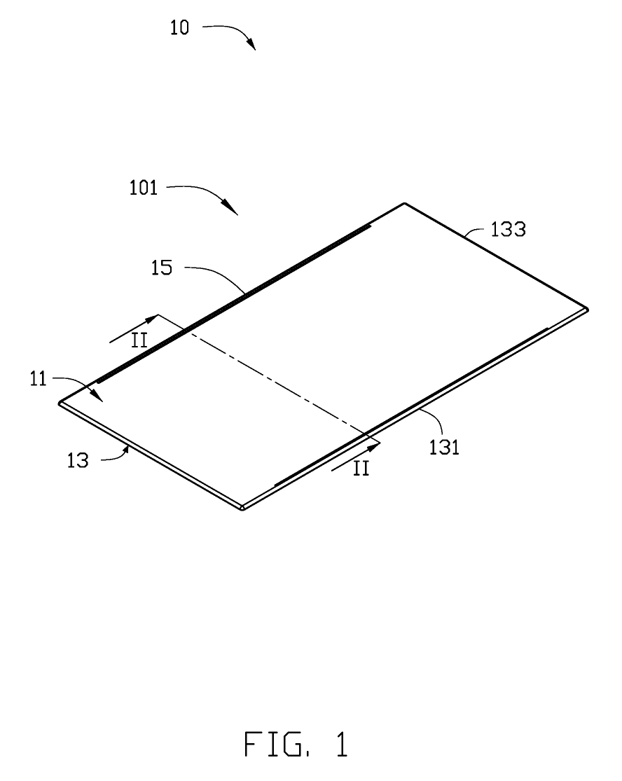

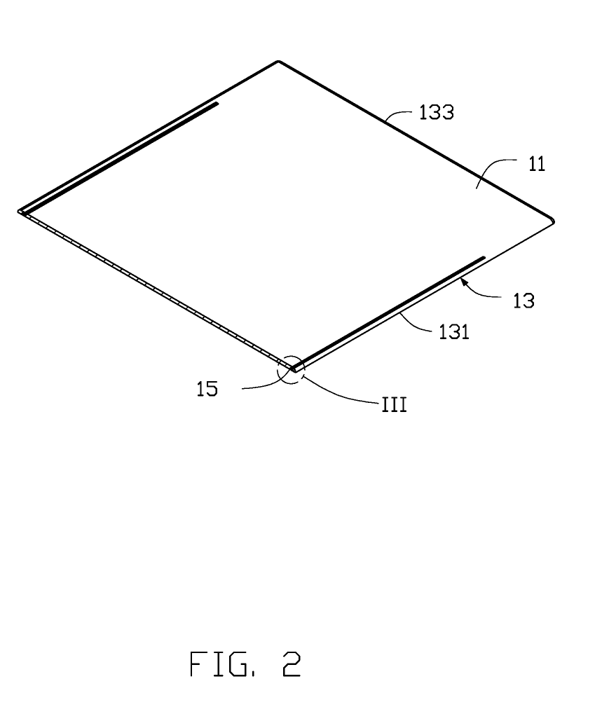

FIGS. 1 and 2 illustrate a screen cover 10 according to a first exemplary embodiment. The screen cover 10 is used for protecting a display screen of an electronic device. The screen cover 10 includes an elongated member 101 having a first side and a second side opposite the first side. In at least embodiment, the elongated member 101 is a flat plate. The elongated member 101 has a first surface 11 on the first side and a second surface 13 on the second side. That is, the first surface 11 is opposite to the second surface 13. When installed, the second surface 13 faces the display screen. The screen cover 10 is transparent and can be made of transparent glass or transparent plastic.

In at least embodiment, the elongated member 101 has two opposite long edges 131 and two opposite short edges 133. The elongated member 101 defines two optical microstructures 15 in the second surface 13. Each optical microstructure 15 is adjacent to one of the long edges 131.

In other embodiments, the second surface 13 may define more than two optical microstructures 15, each optical microstructure 15 is adjacent to one edge. Alternatively, the second surface 13 may define only one optical microstructure 15 adjacent to one edge.

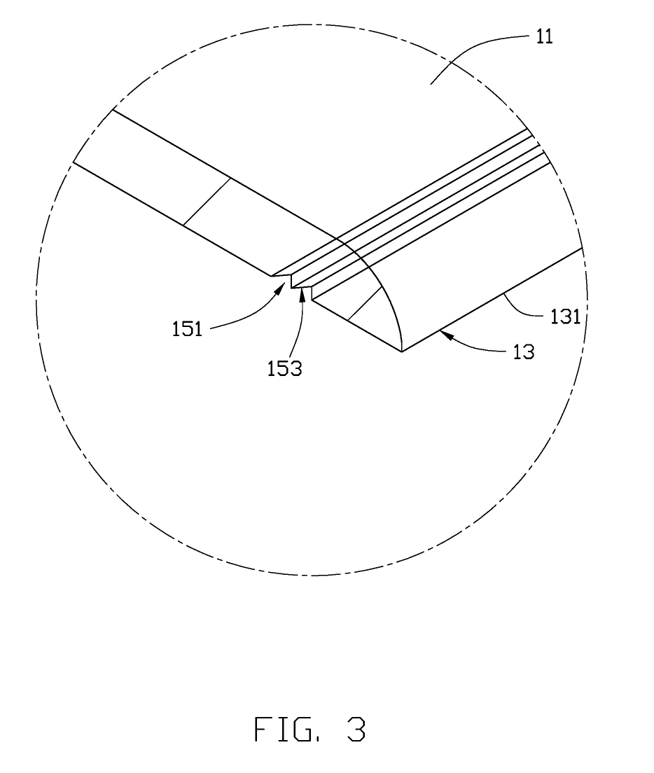

FIG. 3 illustrates the optical microstructure 15 according to a first exemplary embodiment. The optical microstructure 15 includes two grooves 151 extending along a direction which is parallel to the long edge 131. The two grooves 151 are parallel to each other, and a wall 153 of one groove 151 connects a wall 153 of the other groove 151.

In other embodiments, each optical microstructure 15 can include only one groove 151, or more than two grooves 151. When the optical microstructure 15 includes more than two grooves 151, each pair of adjacent grooves 151 are parallel to each other, and a wall 153 of one groove 151 connects a wall 153 of the other groove 151. Each groove 151 extends along a direction which is parallel to the adjacent edge.

The groove 151 can be a V-shaped groove, a circular arced groove, or other shaped groove. In at least embodiment, each optical microstructure 15 includes two connected V-shaped grooves. The V-shaped groove may have a sharp V-shaped bottom end or circular arced bottom end. When the V-shaped groove has a sharp V-shaped bottom end, the sharp V-shaped bottom end may form an angle of any degree, such as 30 degrees, 60 degrees or 90 degrees.

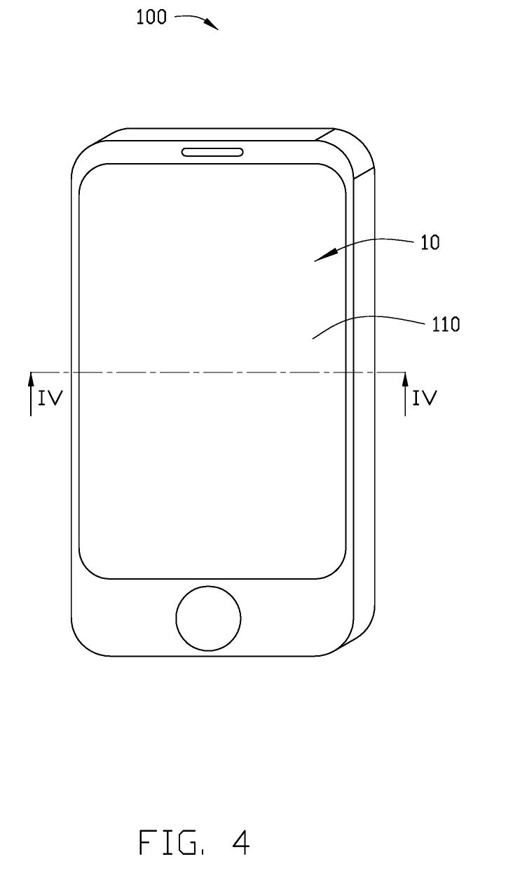

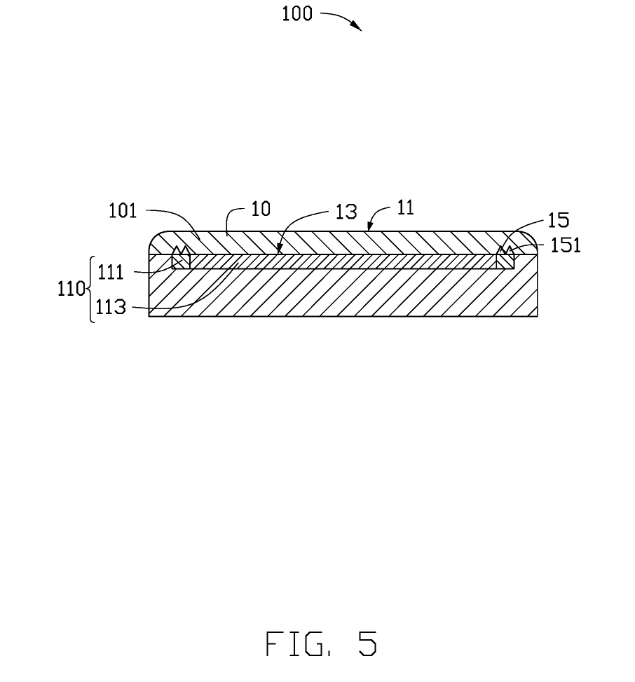

FIGS. 4 and 5 illustrate an electronic device 100 in use of the screen cover 10. The electronic device 100 includes a display screen 110 covered by the screen cover 10. The display screen 110 can be a display panel. The display screen 100 includes a display region 113 and a frame 111 around the display region 113. The second surface 13 of the elongated member 101 is adjacent to the display screen 110, and the optical microstructures 15 face the frame 111. The optical microstructures 15 completely cover the frame 111 in a direction perpendicular to the extending direction of the groove 151.

Light irradiates the groove 151 and refracts, which makes the edges of the display screen 110 and elongated member 101 produce a special visual effect. Thus, when users look at the display screen 110 through the screen cover 10, the users may have a feeling that the frame 11 is narrow or even a feeling of no frame at all.

In one embodiment, the screen cover 10 may be a touch panel, such as a resistive touch panel or a capacitive touch. The electronic device 100 may be a mobile phone, a tablet computer, or any other electronic device having a display screen.

The size and number of the grooves 151 of each optical microstructure 15 can be adjusted according to the width of the frame 111. The length of the grooves 151 can be adjusted according to the length of the frame 111. Additionally, depth of the grooves 151 can be adjusted according to the size of the frame 111.

It is believed that the exemplary embodiment and its advantages will be understood from the foregoing description, and it will be apparent that various changes may be made thereto without departing from the scope of the disclosure or sacrificing all of its advantages, the examples hereinbefore described merely being preferred or exemplary embodiments of the disclosure.

What is claimed is:

1. A screen cover configured to protect a display screen of an electronic device, the screen cover comprising:
an elongated member having a first side and a second side opposite the first side;
a first surface on the first side; and
a second surface on the second side and defining at least one optical microstructure, wherein each of the at least one optical microstructure is adjacent to an edge of the elongated member, and each optical microstructure comprises at least one groove.

2. The screen cover as claimed in claim 1, wherein each optical microstructure comprises two or more grooves, each pair of adjacent grooves are parallel to each other, and a wall of one groove connects a wall of the other groove.

3. The screen cover as claimed in claim 1, wherein each groove extends along a direction which is parallel to an adjacent edge of the elongated member.

4. The screen cover as claimed in claim 1, wherein the groove is a V-shaped groove.

5. The screen cover as claimed in claim 4, wherein the groove has a sharp V-shaped bottom end or a circular arced bottom end.

6. The screen cover as claimed in claim 1, wherein the groove is a circular arced groove.

7. The screen cover as claimed in claim 1, wherein the screen cover is transparent.

8. The screen cover as claimed in claim 1, wherein the screen cover is a touch panel.

9. An electronic device, comprising:
a display screen comprising a display region and a frame around the display region; and
a screen cover covering the display screen, the screen cover comprising:
an elongated member having a first side and a second side opposite the first side;
a first surface on the first side; and
a second surface on the second side and defining at least one optical microstructure;
wherein each of the at least one optical microstructure is adjacent to an edge of the elongated member, and each optical microstructure comprises at least one groove.

10. The electronic device as claimed in claim 9, wherein each optical microstructure comprises two or more grooves, each pair of adjacent grooves are parallel to each other, and a wall of one groove connects a wall of the other groove.

11. The electronic device as claimed in claim 9, wherein each groove extends along a direction which is parallel to an adjacent edge of the elongated member.

12. The electronic device as claimed in claim 11, wherein the optical microstructure completely covers the frame in a direction perpendicular to the extending direction of the groove.

13. The electronic device as claimed in claim 9, wherein the groove is a V-shaped groove.

14. The electronic device as claimed in claim 13, wherein the groove has a sharp V-shaped bottom end or a circular arced bottom end.

15. The electronic device as claimed in claim 9, wherein the groove is a circular arced groove.

16. The electronic device as claimed in claim 9, wherein the screen cover is transparent.

17. The electronic device as claimed in claim 9, wherein the screen cover is a touch panel.
